(19) United States
(12) Patent Application Publication
(10) Pub. No.: US 2022/0321036 A1
(43) Pub. Date: Oct. 6, 2022

(54) MOVING OBJECT, CONTROL METHOD, AND COMPUTER-READABLE STORAGE MEDIUM

(71) Applicant: HONDA MOTOR CO.,LTD., Tokyo (JP)

(72) Inventor: Manabu YATSURUGI, Saitama (JP)

(21) Appl. No.: 17/679,123

(22) Filed: Feb. 24, 2022

(30) Foreign Application Priority Data
Mar. 31, 2021 (JP) 2021-060847

(51) Int. Cl. H02P 5/74; B60L 50/51; B60L 50/60

(52) U.S. Cl. CPC H02P 5/74; B60L 50/51; B60L 50/60; B60L 2210/40; B60L 2240/423; B60L 2240/64

(57) ABSTRACT

There is provided a moving object including: a first motor and a second motor coaxially connected on a shaft configured to drive the moving object; an acquisition unit configured to acquire course information of a course of the moving object; and a torque control unit configured to control torque of the shaft to be increased or decreased by independently switching each of the first motor and the second motor to a magnetization state or a demagnetization state, in which the torque control unit is configured to switch the second motor from one state to the other state between the magnetization state and the demagnetization state, in a case where from the course information, the torque control unit determines that the torque is required to be increased or decreased in the future, while maintaining the magnetization state of the first motor.

The contents of the following Japanese patent application(s) are incorporated herein by reference:

NO. 2021-060847 filed in JP on Mar. 31, 2021

### BACKGROUND

### 1. Technical Field

The present invention relates to a moving object, a control method, and a computer-readable storage medium.

### 2. Related Art

Patent Document 1 discloses that “since the motor outputs allocated to a plurality of motors, respectively, are determined in such a way that the total motor power consumption can be minimized and further the control commands are applied to the respective motors based on the determined motor outputs, the motor travel power is always supplied to the driven wheels under the minimum power consumption” (paragraph 0008).

### CITATION LIST

### Patent Document

[Patent Document 1] Japanese Patent Application Publication No. 6-62508

### BRIEF DESCRIPTION OF THE DRAWINGS

FIG. 1 schematically shows a usage mode of a vehicle 20 according to an embodiment.

FIG. 2 schematically shows a functional configuration of the vehicle 20.

FIG. 3 schematically shows a functional configuration of the vehicle 20.

FIG. 4 shows a flow of a control method for controlling the vehicle 20 according to an embodiment.

FIG. 5 shows a subroutine of the flow of the control method shown in FIG. 4.

FIG. 6 shows an example of a graph for describing motor torque characteristics by a SOC.

FIG. 7 shows an exception handling flow in a case where a failure is detected during the flow of FIG. 4.

FIG. 8 shows an implementation example of a control system 1000 in the vehicle 20.

FIG. 9 shows an example of a computer 2000.

### DESCRIPTION OF EXEMPLARY EMBODIMENTS

Hereinafter, the invention will be described through embodiments of the invention, but the following embodiments do not limit the invention according to claims. Further, not all the combinations of features described in the embodiments are essential for means to solve the problem in the invention.

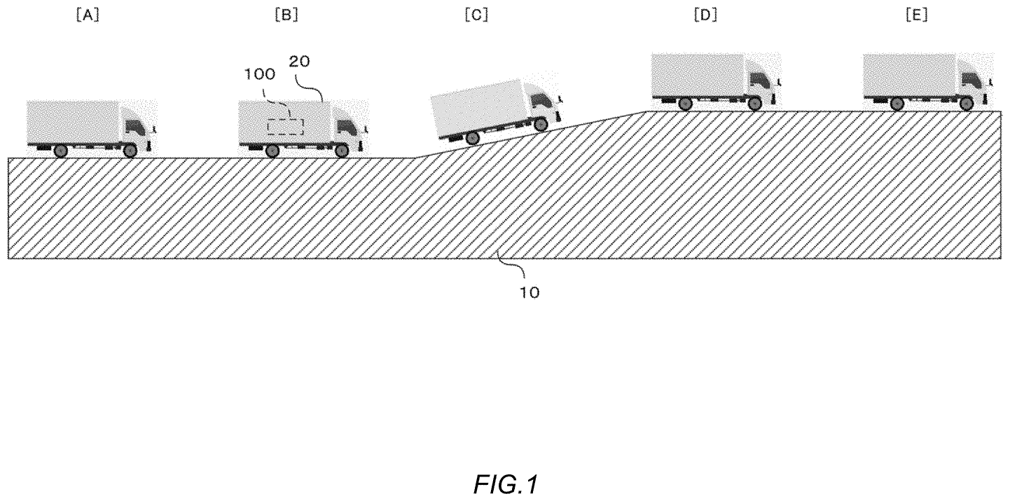

FIG. 1 schematically shows a usage mode of a vehicle 20 according to an embodiment. The vehicle 20 includes a control device 100. The vehicle 20 according to the present embodiment is an electric vehicle that is driven by a plurality of motors. The vehicle 20 may be a hybrid car that is additionally equipped with an internal combustion engine, a fuel cell vehicle (FCV), or the like. The vehicle 20 is an example of a moving object.

As shown in FIG. 1, the vehicle 20 travels on a road 10. The road 10 may include, as an example, an uphill slope, a flat surface, a downhill slope, and the like. The road 10 may be an ordinary road, that is, a low-speed road, or may be a highway. In addition, on the road 10 and around the road 10, indicators showing a shape change such as a presence and absence of a slope of the road 10, and a slope percentage, indicators showing a traffic rule such as a designated speed and a speed limit which are set on the road 10, or the like may be provided.

In FIG. 1, [A], [B], [D], and [E] indicate a state in which the vehicle 20 is traveling on the flat surface of the road 10, and [C] indicates a state in which the vehicle 20 is traveling on the uphill slope of the road 10. The control device 100 of the vehicle 20 aims to prevent a deterioration of energy efficiency in the vehicle 20 traveling on the road 10, and performs a control to magnetize a sub motor before a driving force of the main motor becomes insufficient during the travel, and demagnetize the sub motor before a combined driving force of the main motor and the sub motor becomes excessive.

It should be noted that the road 10 is an example of a course. In the present specification, the course of the vehicle 20 may be intended to be a road on which the vehicle 20 is to advance, a way to go, or a road slightly ahead of the vehicle 20, and refer to any scheduled travel route, with respect to a current location of the vehicle 20, in a direction in which the vehicle 20 is to travel. As a specific example, the course may refer to a road which is several meters to several hundred meters ahead of the vehicle 20 in a travel direction of the vehicle 20. It should be noted that the travel direction may be a direction in which the vehicle 20 moves forward, or may be a direction in which the vehicle 20 moves backward.

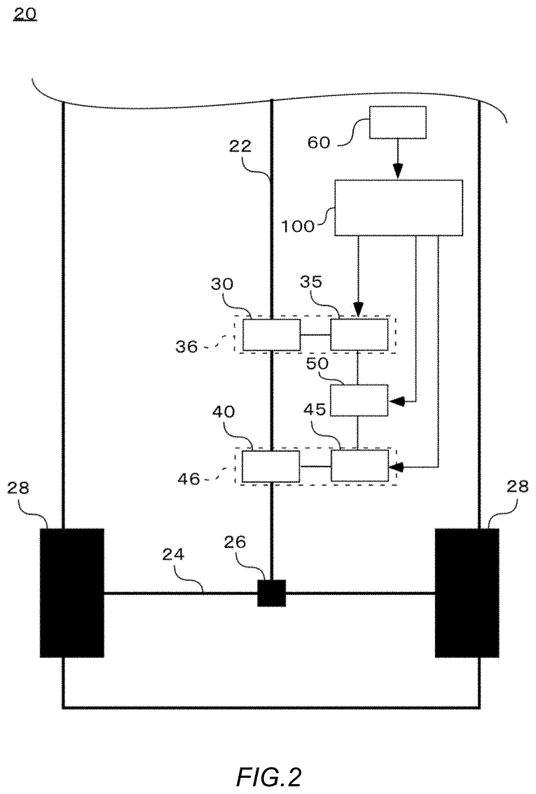

FIG. 2 schematically shows a functional configuration of the vehicle 20. In FIG. 2, a part of the vehicle 20 is not illustrated. In FIG. 2, an input and output of a signal is indicated by an arrow, and an electrical connection and/or a communication connection between respective functional components is indicated by a thin line.

As shown in FIG. 2, the vehicle 20 is equipped with at least a propeller shaft 22, a rear drive shaft 24, a differential gear 26 that transmits torque of the propeller shaft 22 to the rear drive shaft 24, and rear wheels 28 fixed to both ends of the rear drive shaft 24, or the like. The propeller shaft 22 is an example of a shaft that drives the vehicle 20.

The vehicle 20 further includes a first motor 30 and a second motor 40. The vehicle 20 according to the present embodiment further includes a first inverter 35, a second inverter 45, a battery 50, and a detection unit 60. It should be noted that in the following description, the first motor 30 and the first inverter 35 may be referred to as a first unit 36, and similarly, the second motor 40 and the second inverter 45 may be referred to as a second unit 46.

As shown in FIG. 2, the first motor 30 and the second motor 40 are coaxially connected on the propeller shaft 22. The first motor 30 and the second motor 40 may be coaxially connected on another shaft that drives the vehicle 20. It should be noted that the first motor 30 and the second motor 40 may be defined to be connected in series.

The first motor 30 is a main motor being constantly driven to drive the vehicle 20, that is, being constantly in a magnetization state, as long as the first unit 36 does not fail in a state in which an ignition switch of the vehicle 20 is ON.

The second motor 40 is, for example, a sub motor that is controlled to be driven when required torque of the propeller shaft 22, which is required on the road 10 on which the vehicle 20 travels, is estimated to be higher than an output torque of the first motor 30 for the propeller shaft 22. In other words, in a case where the vehicle 20 travels on the road 10 with only the driving force of the first motor 30, when the driving force is expected to be insufficient, the second motor 40 is switched to the magnetization state to add a driving force.

Here, in a case of a motor using a permanent magnet such as an IPM motor, even in a state in which no current is supplied to the motor, a counter electromotive force is generated by a magnetic force acting between a rotor and a stator fixed to a drive shaft, that is, between the permanent magnet and iron, thereby causing a loss in rotational energy of the drive shaft. Such a phenomenon may be referred to as generation of drag torque.

In contrast, the vehicle 20 in the present embodiment includes the first motor 30 and the second motor 40 that can be switched to the magnetization state or a demagnetization state. By setting a motor that is not driven, for example, a sub motor that is not required to be driven, or a motor that cannot be driven due to a failure, or the like, to be in the demagnetization state, the vehicle 20 can suppress an occurrence of the energy loss caused by the drag torque.

It should be noted that the first motor 30 and the second motor 40 are switched to the magnetization state or the demagnetization state by applying a magnetic field from an outside. For example, by causing a large pulsed current to flow through a coil of a stator in the first motor 30 or the like, the magnetic field is generated, and by setting an orientation of the magnetic field to be an orientation opposite to a magnetic direction of a magnet of a rotor in the first motor 30 or the like, the first motor 30 or the like is demagnetized, and by setting the orientation to be the same orientation as the magnetic direction, the first motor 30 or the like is magnetized.

The first inverter 35 controls a rotation speed of the first motor 30 according to a command of the control device 100. The second inverter 45 controls a rotation speed of the second motor 40 according to the command of the control device 100.

The battery 50 supplies power to each of the first inverter 35 and the second inverter 45 according to the command of the control device 100, thereby driving each of the first motor 30 and the second motor 40. It should be noted that the battery 50 may be referred to as a battery of the first motor 30, a battery of the second motor 40, or the like.

As an example, the detection unit 60 includes a plurality of sensor groups, a camera, or the like, and outputs detected information to the control device 100. The detection unit 60 in the present embodiment performs image capturing or sensing of at least any of the indicators on the course and around the course of the vehicle 20. It can be said that the vehicle 20 including such a detection unit 60 is implemented by an ADAS (Advanced Driver Assistance System: an advanced driver assistance system). It should be noted that the ADAS is a general term for various functions to recognize a surrounding situation from sensors such as the camera and a millimeter wave radar mounted on a car, and to highly support a drive of a driver, in addition to support systems such as ABS (Anti-lock Braking System) and brake assist (Brake Assist, BA).

The detection unit 60 in the present embodiment further detects a failure of each of the first motor 30, the second motor 40, the first inverter 35, and the second inverter 45.

The detection unit 60 in the present embodiment further detects a battery level (SOC: State of Capacity) of the battery 50 that supplies the power to the first inverter 35. The detection unit 60 may further detect the SOC of the battery 50 that supplies the power to the second inverter 45.

The detection unit 60 in the present embodiment further detects input information which is input by a user of the vehicle 20, that is, the driver. The input information may include information relating to at least any of an input for accelerating the moving object and an input for decelerating the moving object. The input information is, for example, accelerator opening information or brake information.

The detection unit 60 in the present embodiment further detects a weight of the vehicle 20. The detection unit 60 may include, for example, a stroke sensor, a load cell, or the like arranged on suspension of the vehicle 20.

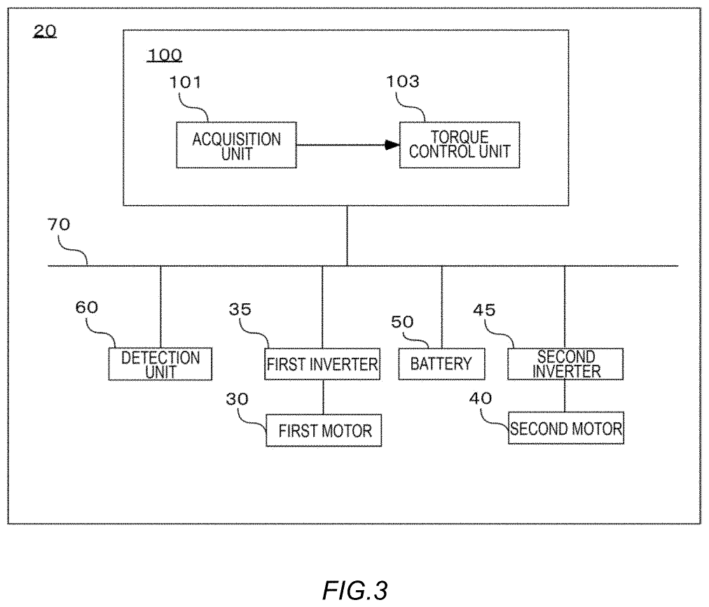

FIG. 3 schematically shows a functional configuration of the vehicle 20. Similarly to FIG. 2, in FIG. 3, an input and output of a signal is indicated by an arrow, and an electrical connection and/or a communication connection between respective functional components is indicated by a thin line.

As shown in FIG. 3, the control device 100, the first inverter 35, the second inverter 45, the battery 50, the detection unit 60, and the like are connected to each other by an in-vehicle network 70. In addition to the control device 100 or the like, the vehicle 20 may include, for example, other drive system device, information and communication system device, or the like, that is, the control device 100 or the like may be connected to the other devices by the in-vehicle network 70. The in-vehicle network 70 may include an Ethernet (registered trademark) network, a CAN (Control Area Network), or the like.

The control device 100 includes an acquisition unit 101 and a torque control unit 103. The acquisition unit 101 acquires course information of the course of the vehicle 20. The course information may at least indicate either that the course of the vehicle 20 is any of the uphill slope, the flat surface, and the downhill slope, or that the course is any of the low speed road and the highway.

The acquisition unit 101 may acquire the course information by estimating the course information based on at least any result of the image capturing or sensing of at least any of the indicators on the course and around the course. The acquisition unit 101 in the present embodiment estimates the course information based on the information which is input from the detection unit 60. The acquisition unit 101 outputs the acquired course information to the torque control unit 103.

The acquisition unit 101 may additionally or alternatively estimate the course information based on at least any of GPS information received from a GPS and map information which is possessed by the moving object. In this case, the acquisition unit 101 may communicate with an external device via a mobile communication network.

The torque control unit 103 controls the torque of the propeller shaft 22 to be increased or decreased by independently switching each of the first motor 30 and the second motor 40 to the magnetization state or the demagnetization state.

The torque control unit 103 switches the second motor 40 from one state to the other state between the magnetization state and the demagnetization state, in a case where from the course information, the torque control unit 103 determines that the torque of the propeller shaft 22 is required to be increased or decreased in the future, while maintaining the magnetization state of the first motor 30.

The torque control unit 103 may control the first motor 30 to 0 torque, and set a state in which the output torque of the first motor 30 is not transmitted to the propeller shaft 22, while switching the second motor 40 from one state to the other state between the magnetization state and the demagnetization state. This makes it possible for the vehicle 20 to avoid an occurrence of a torque shock.

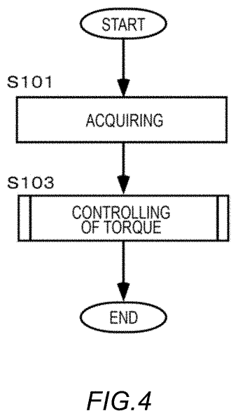

FIG. 4 shows a flow of a control method for controlling the vehicle 20 according to an embodiment. The flow may be started, for example, by the user setting the ignition switch of the vehicle 20 to be in an ON state.

The vehicle 20 executes acquiring the course information of the course of the vehicle 20 (step S101). The vehicle 20 executes controlling the torque of the propeller shaft 22 to be increased or decreased by independently switching each of the first motor 30 and the second motor 40 to the magnetization state or the demagnetization state (step S103).

The controlling of the torque in step S103 includes switching the second motor 40 from one state to the other state between the magnetization state and the demagnetization state, in a case where from the course information, it is determined that the torque is required to be increased or decreased in the future, while the magnetization state of the first motor 30 is maintained.

The vehicle 20 may repeat the flow of FIG. 4, for example, while the ignition switch of the vehicle 20 is in the ON state.

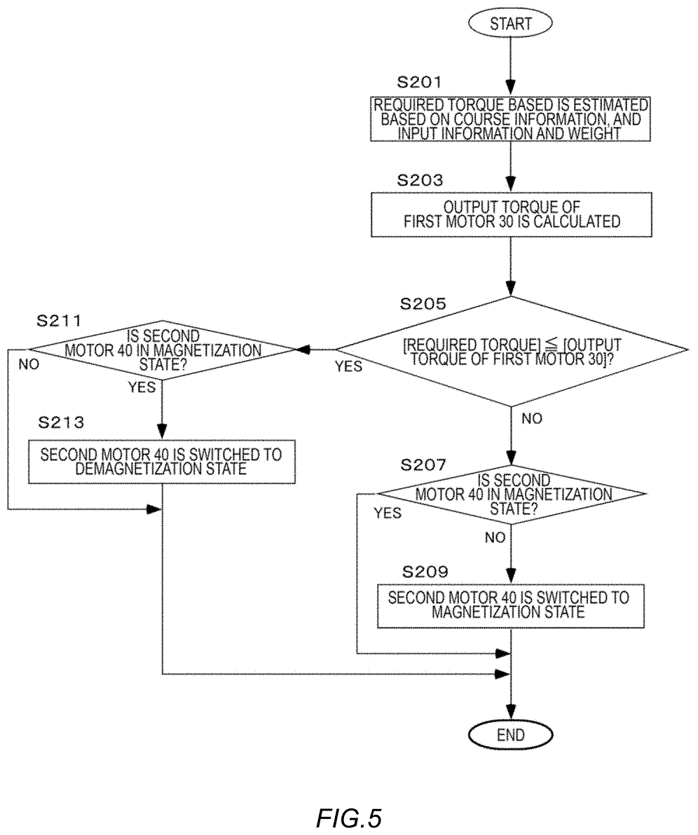

FIG. 5 shows a subroutine of the flow of the control method shown in FIG. 4. The controlling of the torque in step S103 in the flow of FIG. 4 includes a flow shown in FIG. 5. The vehicle 20 starts the flow of FIG. 5 by executing the controlling of the torque in step S103 in the flow of FIG. 4.

The torque control unit 103 in the control device 100 of the vehicle 20 may estimate, based on the course information, the required torque of the propeller shaft 22 which is required in the course. The torque control unit 103 may estimate the required torque based on the course information, and at least any of the input information described above and the weight of the vehicle 20. It should be noted that by referring to a memory of the control device 100, the torque control unit 103 may estimate the required torque by using: a function indicating a relationship between the course information and the required torque; a function indicating a relationship between accelerator opening and the required torque; a function indicating a relationship between the weight of the vehicle 20 and the required torque; a function indicating a relationship between the course information, at least any of the accelerator opening and the weight of the vehicle 20, and the required torque; or the like.

In the present embodiment, the vehicle 20 estimates the required torque based on the course information, and the input information and the weight (step S201).

The torque control unit 103 may calculate the output torque of the first motor 30 in the magnetization state based on the SOC of the battery 50 that supplies the power to the first motor 30. In addition, the torque control unit 103 may determine whether the torque of the propeller shaft 22 is required to be increased or decreased in the future based on the estimated required torque and the output torque of the first motor 30 in the magnetization state.

In the present embodiment, the vehicle 20 calculates the output torque of the first motor 30 (step S203), and determines whether the estimated required torque is less than or equal to the output torque of the first motor 30 (step S205).

The torque control unit 103 may control the second motor 40 to be switched to the demagnetization state so as to decrease the torque, in a case where the torque control unit 103 determines that the estimated required torque is less than or equal to the output torque of the first motor 30, while maintaining the magnetization state of the first motor 30 and the second motor 40. In addition, the torque control unit 103 may control the second motor 40 to be switched to the magnetization state so as to increase the torque, in a case where the torque control unit 103 determines that the required torque is higher than the output torque of the first motor 30, while maintaining the magnetization state of the first motor 30 and the demagnetization state of the second motor 40.

In the present embodiment, in a case where the vehicle 20 determines that the estimated required torque is less than or equal to the output torque of the first motor 30 (step S205: YES), when the second motor 40 is in the magnetization state (step S211: YES), the vehicle 20 switches the second motor 40 to the demagnetization state (step S213), and ends the flow. In addition, in a case where the vehicle 20 determines that the estimated required torque is less than or equal to the output torque of the first motor 30 (step S205: YES), when the second motor 40 is not in the magnetization state (step S211: NO), the vehicle 20 ends the flow.

In addition, in a case where the vehicle 20 determines that the estimated required torque is higher than the output torque of the first motor 30 (step S205: NO), when the second motor 40 is not in the magnetization state (step S207: NO), the vehicle 20 switches the second motor 40 to the magnetization state (step S209), and ends the flow. In addition, in a case where the vehicle 20 determines that the estimated required torque is higher than the output torque of the first motor 30 (step S205: NO), when the second motor 40 is in the magnetization state (step S207: YES), the vehicle 20 ends the flow.

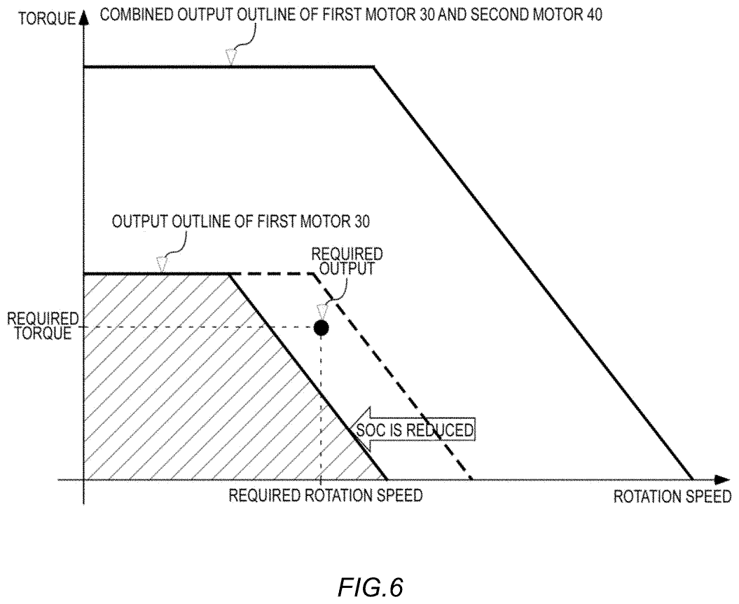

FIG. 6 shows an example of a graph for describing motor torque characteristics by a SOC. The horizontal axis of the graph indicates the rotation speed, and the vertical axis indicates the torque. In the graph, an output outline of the first motor 30, and a combined output outline of the first motor 30 and the second motor 40 are respectively indicated by thick lines. Note that in the graph, for the output outline of the first motor 30, a state before the battery level of the battery 50, that is, the SOC is reduced is indicated by a dashed line, and a state after the SOC is reduced is indicated by a solid line. In addition, between the dashed line and the solid line in the graph, a transition direction of the output outline of the first motor 30 due to the reduction in SOC is indicated by a white arrow. It should be noted that the output outline of the first motor 30 described above is intended to be the output outline of the vehicle 20 when only the first motor 30 is driven, and the combined output outline described above is intended to be the output outline of the vehicle 20 when both of the first motor 30 and the second motor 40 are driven.

In addition, in the graph, a required output which is required while the vehicle 20 is traveling in the course is indicated by a black dot, and the required torque and a required rotation speed corresponding to the required output are respectively indicated on the vertical axis and the horizontal axis. In addition, in the graph, a range in which the first motor 30 is capable of outputting after the SOC of the battery 50 is reduced is indicated by a shaded area.

As described above, the torque control unit 103 may calculate the output torque of the first motor 30 in the magnetization state based on the SOC of the battery 50, and determine whether the torque of the propeller shaft 22 is required to be increased or decreased in the future based on the estimated required torque and the output torque. For example, in the graph of FIG. 6, in the state where only the first motor 30 is driven, when a required output point is not located within the range in which the first motor 30 is capable of outputting, the torque control unit 103 may determine that the torque of the propeller shaft 22 is required to be increased in the future, and switch the second motor 40 to the magnetization state. In addition, for example, in the state where both of the first motor 30 and the second motor 40 are driven, when the required output point is located within the range in which the first motor 30 is capable of outputting, the torque control unit 103 may determine that the torque of the propeller shaft 22 is required to be decreased in the future, and switch the second motor 40 to the demagnetization state. In this way, the vehicle 20 independently switches each of the first motor 30 and the second motor 40 to the magnetization state or the demagnetization state to more efficiently drive the vehicle 20.

It should be noted that the control device 100 may store, in the memory, a function indicating a relationship between the rotation speed and the torque for specifying at least the output outline of the first motor 30, and the combined output outline of the first motor 30 and the second motor 40, respectively. The control device 100 may store, in the memory, a function for specifying an output outline of the second motor 40.

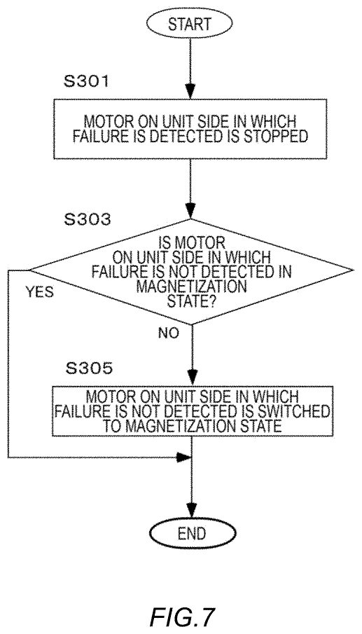

FIG. 7 shows an exception handling flow in a case where a failure is detected during the flow of FIG. 4. For example, the vehicle 20 starts the flow of FIG. 7 when the failure is detected in any one of the first unit 36 and the second unit 46 during the flow of FIG. 4. In other words, when detecting the failure at any timing in the flow of FIG. 4, the vehicle 20 stops the flow of FIG. 4, and switches to the exception handling flow of FIG. 7.

The torque control unit 103 may perform, regardless of the course information, when the failure of one of the first unit 36 and the second unit 46 is detected, a control so as to (1) stop the motor on one side in which the failure is detected, and maintain the magnetization state of the motor on the other side, or (2) stop the motor on the one side, and switch the motor on the other side to the magnetization state. It should be noted that by executing a three phase short circuit control or all phase interruption of an inverter on a unit side in which the failure is detected, the torque control unit 103 may stop the motor on the unit side.

In the present embodiment, the vehicle 20 stops the motor on the unit side in which the failure is detected (step S301), and when the motor on a unit side in which the failure is not detected is not in the magnetization state (step S303: NO), the vehicle 20 switches the motor to the magnetization state, and ends the flow. In addition, the vehicle 20 ends the flow when the motor on the unit side in which the failure is not detected is in the magnetization state (step S303: YES).

After switching to the exception handling flow of FIG. 7, the vehicle 20 does not resume the flow of FIG. 4 as long as the failure is detected, that is, until a portion where the failure has occurred is repaired. For example, in a case where the failure is not detected any longer while the ignition switch of the vehicle 20 is in the ON state, the flow of FIG. 4 may be resumed. In addition, when the ignition switch of the vehicle 20 is changed from an OFF state to the ON state, as long as the failure is not detected, the flow of FIG. 4 may be resumed.

As Comparison Example 1 of the vehicle 20 including the control device 100 according to the present embodiment, for example, after the vehicle that has begun to travel on the uphill slope gets into a state in which the driving force of the main motor is insufficient, it is conceivable to control the main motor to 0 torque to avoid the torque shock, magnetize the sub motor, and then start the drive with both motors. In this case, by controlling the main motor to 0 torque while climbing the slope, an excessive torque loss occurs, and thus an energy loss occurs at a time of reaccelerating the vehicle of which a speed has suddenly reduced.

In addition, as Comparison Example 2 of the vehicle 20 including the control device 100, for example, after the vehicle that has finished climbing the uphill slope in the state in which both of the main motor and the sub motor are driven, enters a flat road or the downhill slope, and gets into a state in which the driving force by both motors is excessive, it is conceivable to demagnetize the sub motor. In this case, the state in which the driving force is excessive causes the energy loss.

In contrast, with the vehicle 20 including the control device 100 according to the present embodiment, the course information of the course of the vehicle 20 is acquired, and the second motor 40 is controlled to be switched from one state to the other state between the magnetization state and the demagnetization state, in a case where from the course information, it is determined that the torque of the propeller shaft 22 is required to be increased or decreased in the future, while the magnetization state of the first motor 30 is maintained. For example, the vehicle 20 switches the second motor 40 to the magnetization state before reaching the uphill slope or a high speed section, in a state of maintaining the magnetization state of the first motor 30, and then the vehicle 20 switches the second motor 40 to the demagnetization state before reaching the flat road, the downhill slope, or a low speed section.

With the vehicle 20 having such a configuration, it is possible to avoid the energy loss due to the excessive torque loss as in Comparison Example 1 described above, and the energy loss due to the excessive driving force as in Comparison Example 2 described above, or the like, and thus it is possible to prevent a deterioration of energy efficiency. In addition, the vehicle 20 can enhance estimation accuracy by considering the input information such as the accelerator opening information, the weight of the vehicle 20, or the like, when estimating the required torque which is required for the vehicle 20 to travel in the course. In addition, similarly, by calculating the output torque of the first motor 30 in the magnetization state, in consideration of the SOC of the battery 50 that supplies the power to the first motor 30, to determine that the torque of the propeller shaft 22 is required to be increased or decreased in the future, the vehicle 20 can improve accuracy of the determination.

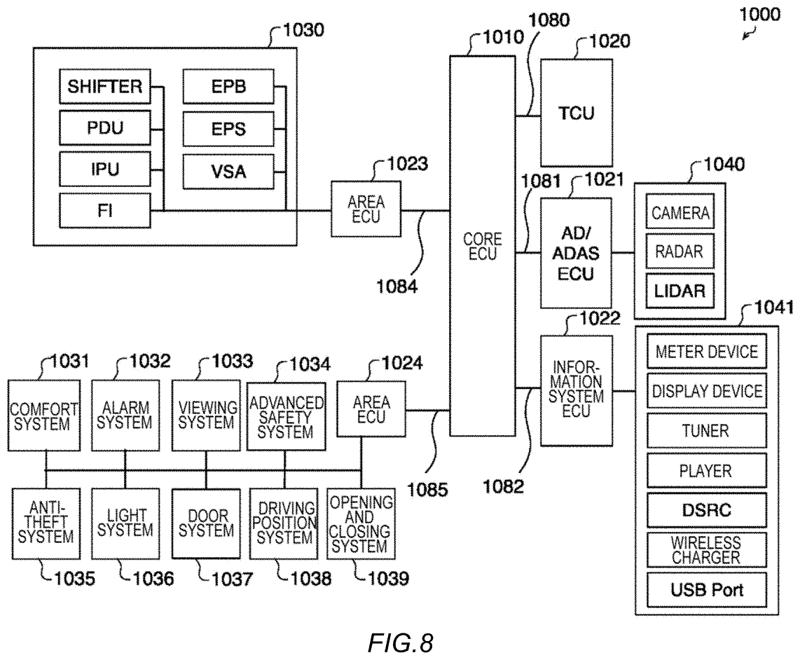

FIG. 8 shows an implementation example of a control system in the vehicle 20. A control system 1000 includes a core ECU 1010, a TCU 1020, an AD/ADAS ECU 1021, an information system ECU 1022, an area ECU 1023, an area ECU 1024, a sensor device 1040, an information system device 1041, a drive system device 1030, a comfort system device 1031, an alarm system device 1032, a viewing system device 1033, an advanced safety system device 1034, an anti-theft system device 1035, a light system device 1036, a door system device 1037, a driving position system device 1038, an opening and closing system device 1039, a communication network 1080, a communication network 1081, a communication network 1082, a communication network 1084, and a communication network 1085. The AD/ADAS ECU 1021 is an ECU that performs a control which relates to autonomous driving (AD) and the advanced driver assistance system (ADAS).

The TCU 1020 is a telematics control unit. The TCU 1020 is an implementation example of the control device 100 described above. It should be noted that the TCU 1020 and the core ECU 1010 may cooperate with each other to function as the control device 100 described above.

The communication network 1080, the communication network 1081, the communication network 1082, the communication network 1084, and the communication network 1085 are implementation examples of an in-vehicle network 29. The communication network 1080, the communication network 1081, the communication network 1082, the communication network 1084, and the communication network 1085 may include the Ethernet (registered trademark) network. The TCU 1020, the core ECU 1010, the AD/ADAS ECU 1021, the information system ECU 1022, the area ECU 1023, and the area ECU 1024 may be capable of IP communications via the communication network 1080, the communication network 1081, the communication network 1082, the communication network 1084, and the communication network 1085. It should be noted that the communication network 1084 and the communication network 1085 may include the CAN.

The sensor device 1040 has a sensor including a camera, a radar, and a LIDAR. The AD/ADAS ECU 1021 is connected to each sensor included in the sensor device 1040 through a bus, controls each sensor included in the sensor device 1040, to acquire information detected by each sensor.

The information system device 1041 has a device including a meter device, a display device, a tuner, a player, a DSRC (Dedicated Short Range Communications) system, a wireless charger, and a USB port. The information system ECU 1022 is connected to each device included in the information system device 1041 through the bus, and controls each device included in the information system device 1041. The information system device 1041 includes an information communication device, a multimedia-related device, and a user interface device.

The drive system device 1030 has a device including an electronic parking brake (EPB), an electric power steering system (EPS), a vehicle behavior stabilization control system (VSA), a shifter (SHIFTER), a power drive unit (PDU), and an intelligent power unit (IPU), and a fuel injection (FI) device. The drive system device 1030 is connected to each device included in the drive system device 1030 through the bus, and controls each device included in the drive system device 1030.

The area ECU 1024 is connected, through the bus, to the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039; and controls devices included in the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039. The area ECU 1024 is connected to the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039. The comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039 mainly include auxiliary devices of the vehicle 20.

The drive system device 1030, the sensor device 1040, the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039 are devices of the control system of the vehicle 20. The information system device 1041 is a device of the non-control system.

The data communication, which relates to the device included in the sensor device 1040, the drive system device 1030. the comfort system device 1031, the alarm system device 1032, the viewing system device 1033, the advanced safety system device 1034, the anti-theft system device 1035, the light system device 1036, the door system device 1037, the driving position system device 1038, and the opening and closing system device 1039, may have a lower priority than that of the data communication which relates to the device included in the information system device 1041.

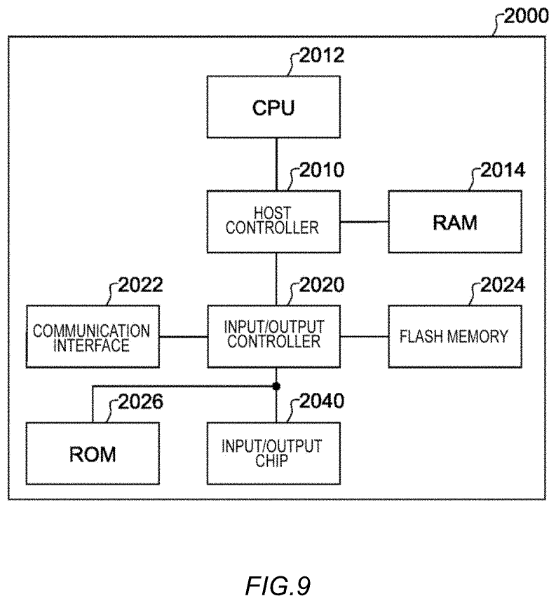

FIG. 9 shows an example of a computer 2000 in which a plurality of embodiments of the present invention may be entirely or partially embodied. A program installed on the computer 2000 can cause the computer 2000 to function as a device such as the information processing device or each unit of the device according to the embodiment, or to execute an operation associated with the device or each unit of the device, and/or to execute a process or steps of the process according to the embodiment. Such a program may be executed by a CPU 2012 to cause the computer 2000 to execute the specific operation associated with some or all of the blocks of the processing procedure and the block diagram described in the present specification.

The computer 2000 according to the present embodiment includes the CPU 2012, and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to the programs stored in the ROM 2026 and the RAM 2014, thereby controlling each unit.

The communication interface 2022 communicates with other electronic devices via a network. The flash memory 2024 stores programs and data used by the CPU 2012 in the computer 2000. The ROM 2026 stores a boot program or the like that is executed by the computer 2000 during activation, and/or a program that depends on hardware of the computer 2000. In addition, the input/output chip 2040 may connect various input/output units such as a keyboard, a mouse, and a monitor to the input/output controller 2020 via an input/output port such as a serial port, a parallel port, a keyboard port, a mouse port, a monitor port, a USB port, an HDMI (registered trademark) port.

A program is provided via a computer-readable storage medium such as a CD-ROM, a DVD-ROM, or a memory card, or a network. The RAM 2014, the ROM 2026, or the flash memory 2024 is an example of the computer-readable storage medium. The program is installed in the flash memory 2024, the RAM 2014, or the ROM 2026, and is executed by the CPU 2012. Information processing written in these programs is read by the computer 2000, resulting in cooperation between a program and the various types of hardware resources described above. A device or a method may be configured by implementing the operation or process of the information according to the use of the computer 2000.

For example, when a communication is executed between the computer 2000 and an external device, the CPU 2012 may execute a communication program loaded in the RAM 2014, and instruct the communication interface 2022 to process the communication based on the processing written in the communication program. Under the control of the CPU 2012, the communication interface 2022 reads transmission data stored in a transmission buffer region provided in a recording medium such as the RAM 2014 and the flash memory 2024, transmits the read transmission data to the network, or writes received data which is received from the network to a receiving buffer region or the like provided on the recording medium.

In addition, the CPU 2012 may cause all or a necessary portion of a file or a database to be read into the RAM 2014, the file or the database having been stored in the recording medium such as the flash memory 2024, etc., and perform various types of processing on the data on the RAM 2014. The CPU 2012 then writes back the processed data to the recording medium.

Various types of information, such as various types of programs, data, tables, and databases, may be stored in the recording medium to undergo information processing. The CPU 2012 may execute various types of processing on the data read from the RAM 2014 to write back a result to the RAM 2014, the processing being described in the present specification, specified by instruction sequences of the programs, and including various types of operations, information processing, condition determinations, conditional branching, unconditional branching, information retrievals/replacements, or the like. In addition, the CPU 2012 may search for information in a file, a database, etc., in the recording medium. For example, when a plurality of entries, each having an attribute value of a first attribute associated with an attribute value of a second attribute, are stored in the recording medium, the CPU 2012 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The program or software module described above may be stored on the computer 2000 or in a computer-readable storage medium near the computer 2000. A recording medium such as a hard disk or a RAM provided in a server system connected to a dedicated communication network or the Internet can be used as a computer-readable storage medium. The program stored in the computer-readable storage medium may be provided to the computer 2000 via the network.

A program, which is installed on the computer 2000 and causes the computer 2000 to function as a control device 100, may work on the CPU 2012 or the like to cause the computer 2000 to function as each unit of the control device 100. Information processing written in these programs functions as each unit of the control device 100 that is specific means by which software and the above-described various hardware resources cooperate by being read by the computer 2000. Then, by the specific means realizing calculation or processing of information according to a purpose of use of the computer 2000 in the present embodiment, the unique control device 100 according to the purpose of use is constructed.

Various embodiments have been described with reference to the block diagrams or the like. Blocks in the block diagrams may respectively represent (1) steps of processes in which operations are performed or (2) “units” of apparatuses responsible for performing operations. Certain steps and “units” may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits, and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), and the like.

Computer-readable storage media may include any tangible device that can store instructions to be executed by a suitable device, and as a result, the computer-readable storage medium having the instructions stored thereon constitutes at least a part of an article of manufacture including instructions which can be executed to create means for performing operations specified in the processing procedures or block diagrams. Examples of computer-readable storage media may include an electronic storage medium, a magnetic storage medium, an optical storage medium, an electromagnetic storage medium, a semiconductor storage medium, etc. Specific examples of the computer-readable storage medium may include a floppy (Registered Trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a portable compact disc read-only memory (CD-ROM), a digital versatile disc (DVD), a Blu-ray (registered trademark) disc, a memory stick, an integrated circuit card, or the like.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk(registered trademark), JAVA(registered trademark), C++, etc., and conventional procedural programming languages, such as the “C” programming language or similar programming languages.

Computer-readable instructions may be provided to a processor of a general-purpose computer, special purpose computer, or other programmable data processing apparatus, or to programmable circuitry, locally or via a local area network (LAN), wide area network (WAN) such as the Internet, etc., so that the computer-readable instructions is executed to create means for performing operations specified in the described processing procedures or block diagrams. Examples of the processor include a computer processor, a processing unit, a microprocessor, a digital signal processor, a controller, a microcontroller, and the like.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

For example, the vehicle 20 and the control device 100 may respectively include one or more functional blocks other than the functional blocks shown in FIG. 2 and FIG. 3.

For example, the vehicle 20 may include three or more sets of the first unit 36 or the like, that is, may include three or more motors connected in series, or may further additionally include one or more motors connected in parallel. It should be noted that these units can be individually controlled by the control device 100.

For example, in addition to a four wheel car such as the vehicle 20, as the moving object including the control device 100, any motor-driven object such as a saddle riding type vehicle and a ship, in addition to other automobiles such as a two wheel car and a three wheel car, may be used. In addition, the moving object is not limited to transportation equipment on which a person is carried, and may be any movable equipment, for example, equipment that operates unmanned.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 road; 20 vehicle; 22 Propeller shaft; 24 rear drive shaft; 26 differential gear; 28 rear wheel; 30 first motor; 35 first inverter; 36 first unit; 40 second motor; 45 second inverter; 46 second unit; 50 battery; 60 detection unit; 70 in-vehicle network; 100 control device; 101 acquisition unit; 103 torque control unit; 1000 control system; 1010 core ECU; 1020 TCU; 1021 AD/ADAS ECU; 1022 information system ECU; 1023 area ECU; 1024 area ECU; 1030 drive system device; 1031 comfort system device; 1032 alarm system device; 1033 viewing system device; 1034 advanced safety system device; 1035 anti-theft system device; 1036 light system device; 1037 door system device; 1038 driving position system device; 1039 opening and closing system device; 1040 sensor device; 1041 information system device; 1080 communication network; 1081 communication network; 1082 communication network; 1084 communication network; 1085 communication network; 2000 computer; 2010 host controller; 2012 CPU; 2014 RAM; 2020 input/output controller; 2022 communication interface; 2024 flash memory; 2026 ROM; 2040 input/output chip

What is claimed is:

1. A moving object comprising:
a first motor and a second motor coaxially connected on a shaft configured to drive the moving object;
an acquisition unit configured to acquire course information of a course of the moving object; and
a torque control unit configured to control torque of the shaft to be increased or decreased by independently switching each of the first motor and the second motor to a magnetization state or a demagnetization state, wherein
the torque control unit is configured to switch the second motor from one state to another state between the magnetization state and the demagnetization state, in a case where from the course information, the torque control unit determines that the torque is required to be increased or decreased in the future, while maintaining the magnetization state of the first motor.

2. The moving object according to claim 1, wherein
the torque control unit is configured to estimate, based on the course information, required torque of the shaft which is required in the course, and
determine whether the torque is required to be increased or decreased in the future based on the required torque and an output torque of the first motor in the magnetization state.

3. The moving object according to claim 2,
wherein
the torque control unit is configured to calculate the output torque of the first motor in the magnetization state based on a battery level of the first motor.

4. The moving object according to claim 2,
wherein
the torque control unit is configured to estimate the required torque of the shaft which is required in the course based on the course information, and at least any of input information which is input by a user of the moving object and a weight of the moving object.

5. The moving object according to claim 3,
wherein
the torque control unit is configured to estimate the required torque of the shaft which is required in the course based on the course information, and at least any of input information which is input by a user of the moving object and a weight of the moving object.

6. The moving object according to claim 4,
wherein
the input information includes information relating to at least any of an input for accelerating the moving object and an input for decelerating the moving object.

7. The moving object according to claim 5,
wherein
the input information includes information relating to at least any of an input for accelerating the moving object and an input for decelerating the moving object.

8. The moving object according to claim 2,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

9. The moving object according to claim 3,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

10. The moving object according to claim 4,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

11. The moving object according to claim 5,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

12. The moving object according to claim 6,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

13. The moving object according to claim 7,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

14. The moving object according to claim 8,
wherein
the torque control unit is configured to control the second motor to be switched to the demagnetization state so as to decrease the torque, in a case where the torque control unit determines that the required torque is less than or equal to the output torque of the first motor, while maintaining the magnetization state of the first motor and the second motor.

15. The moving object according to claim 2,
wherein
the torque control unit is configured to control the second motor to be switched to the magnetization state so as to increase the torque, in a case where the torque control unit determines that the required torque is higher than the output torque of the first motor, while maintaining the magnetization state of the first motor and the demagnetization state of the second motor.

16. The moving object according to claim 1,
wherein
the torque control unit is configured to control the first motor to 0 torque, and set a state in which output torque of the first motor is not transmitted to the shaft, while switching the second motor from one state to the other state between the magnetization state and the demagnetization state.

17. The moving object according to claim 1,
wherein
the course information at least indicates either that the course is any of an uphill slope, a flat surface, and a downhill slope, or that the course is any of a low speed road and a highway, and
the acquisition unit is configured to acquire the course information by at least any of (1) estimating the course information based on at least any result of image capturing or sensing of at least any of indicators on the course and around the course, and (2) estimating the course information based on at least any of GPS information received from a GPS and map information which is possessed by the moving object.

18. The moving object according to claim 1,
further comprising:
a first inverter configured to control a rotation speed of the first motor, and a second inverter configured to control a rotation speed of the second motor; and
a detection unit configured to detect a failure of each of the first motor, the second motor, the first inverter, and the second inverter, wherein
the torque control unit is configured to perform, regardless of the course information, when the failure of one of at least any of the first motor and the first inverter, and at least any of the second motor and the second inverter is detected, a control so as to (1) stop the motor on one side in which the failure is detected, and maintain the magnetization state of the motor on the other side, or (2) stop the motor on the one side, and switch the motor on the other side to the magnetization state.

19. A control method for controlling a moving object comprising:
acquiring course information of a course of the moving object; and
controlling torque of a shaft, which is configured to drive the moving object, to be increased or decreased by independently switching each of a first motor and a second motor, which are coaxially connected on the shaft, to a magnetization state or a demagnetization state, wherein
the controlling of the torque includes switching the second motor from one state to another state between the magnetization state and the demagnetization state, in a case where from the course information, it is determined that the torque is required to be increased or decreased in the future, while the magnetization state of the first motor is maintained.

20. A computer-readable storage medium having stored thereon a program for controlling a moving object, the program causing, when executed by a computer, the computer to perform operations comprising:
acquiring course information of a course of the moving object; and
controlling torque of a shaft, which is configured to drive the moving object, to be increased or decreased by independently switching each of a first motor and a second motor, which are coaxially connected on the shaft, to a magnetization state or a demagnetization state, wherein
the controlling of the torque includes switching the second motor from one state to another state between the magnetization state and the demagnetization state, in a case where from the course information, it is determined that the torque is required to be increased or decreased in the future, while the magnetization state of the first motor is maintained.
